(19) United States
(12) Patent Application Publication
(10) Pub. No.: US 2020/0245672 A1
(43) Pub. Date: Aug. 6, 2020

(54) PLANT FOR PUFFING PASTA AND LEGUMES AND RELATIVE PRODUCTS

(71) Applicants: Manuela Cataudella, Castiglione Del Lago (PG) (IT); Diego Cataudella, Castiglione Del Lago (PG) (IT)

(72) Inventors: Manuela Cataudella, Castiglione Del Lago (PG) (IT); Diego Cataudella, Castiglione Del Lago (PG) (IT)

(21) Appl. No.: 16/753,622

(22) PCT Filed: Oct. 3, 2018
(86) PCT No.: PCT/IB2018/057693

§ 371 Date: Apr. 3, 2020

(30) Foreign Application Priority Data
Oct. 3, 2017 (IT) 102017000110747

(51) Int. Cl. A23P 30/32; A23L 11/00; A23L 7/109; A23L 5/20; F26B 17/10

(52) U.S. Cl. CPC A23P 30/32; A23L 11/03; F26B 17/106; A23L 5/21; A23L 7/109

(57) ABSTRACT

A plant for the production of puffed pasta or puffed legumes comprising a cooker/dryer assembly, which is supplied with pasta or raw legumes and is designed to carry out a partial cooking of the pasta or of the legumes and a partial drying thereof, a puffing assembly, where the pasta or the legumes are puffed, and a collecting tank, into which the pasta or the legumes that have been subjected to the puffing process are conveyed. The cooker/dryer assembly comprises a cooking pipe, which is designed to house pasta or legumes in a running manner, heating means, which are designed to heat the pipe, moving means, which are designed to rotate the pipe around a longitudinal axis thereof, inclination means, which are designed to incline the pipe, a plurality of controlled running partitions, which are housed inside the pipe and are designed to slow down the running of pasta or legumes inside the pipe, and a plurality of mixing blades, which are housed inside the pipe and are designed to mix pasta or legumes inside the pipe.

### CROSS-REFERENCE TO RELATED APPLICATIONS

This application claims priority from Italian Patent Application No. 102017000110747 filed on Mar. 10, 2017, the disclosure of which is incorporated by reference.

### TECHNICAL FIELD

The invention relates to a plant for puffing pasta or legumes. Furthermore, the invention also relates to pasta and legumes obtained with a puffing method according to the invention.

Pasta is the main Italian food and is highly appreciated not only for its organoleptic properties, but also for its nutritional qualities.

In particular, over the last few years pasta has proven to play an extremely important role in athletes' diet, thanks to its suitable content of complex carbohydrates, proteins, fibres.

### BACKGROUND ART

As it is known, pasta is generally eaten during meals such as dinner or lunch and after a certain preparation procedure, which involves the cooking thereof, usually in boiling water, as well as a seasoning phase.

Furthermore, pasta, due to its consistency, must usually be eaten in a seated situation.

Owing to the above, pasta, like we know it nowadays, cannot evidently be considered a food to be consumed in every moment of the day, for instance at breakfast or during a mid-morning or mid-afternoon break, or in any situation in which a person might be.

On the other hand, legumes are a food whose beneficial qualities are now self-evident. Indeed, their content of fibres and proteins makes them a food that is generally suggested by all specialists. Nevertheless, many people, in particular children, do not appreciate legumes from an organoleptic point of view and, therefore, they cannot benefit from their advantages.

The inventors of this invention offer a solution that can be applied both to pasta and to legumes and is capable of overcoming the relative problems described above.

In particular, the invention surprisingly proved to be capable of also leading to improvements in the nutritional features both of pasta and of legumes.

The invention is based on the puffing of pasta and of legumes.

### DISCLOSURE OF INVENTION

The subject-matter of the invention is a plant for puffing pasta and legumes, whose essential features are set forth in claim 1, and whose preferred and/or auxiliary features are set forth in claims 2-7.

A further subject-matter of the invention is the puffed pasta or the puffed legumes obtained with the plant according to the invention.

Another subject-matter of the invention is a food product comprising the puffed pasta or the puffed legumes obtained with the plant according to the invention.

### BRIEF DESCRIPTION OF THE DRAWINGS

Hereinafter there is a description of an embodiment of the invention, by mere way of explanatory and non-limiting example, with reference to the accompanying drawings, wherein:

FIG. 1 shows, in an extremely schematic manner, the plant according to the invention as a whole;

FIG. 2 is a longitudinal section of an element of the plant according to the invention;

FIG. 2a is a front view of a detail of the element of FIG. 2; and

FIG. 3 is a longitudinal section of a further element of the plant according to the invention.

### BEST MODE FOR CARRYING OUT THE INVENTION

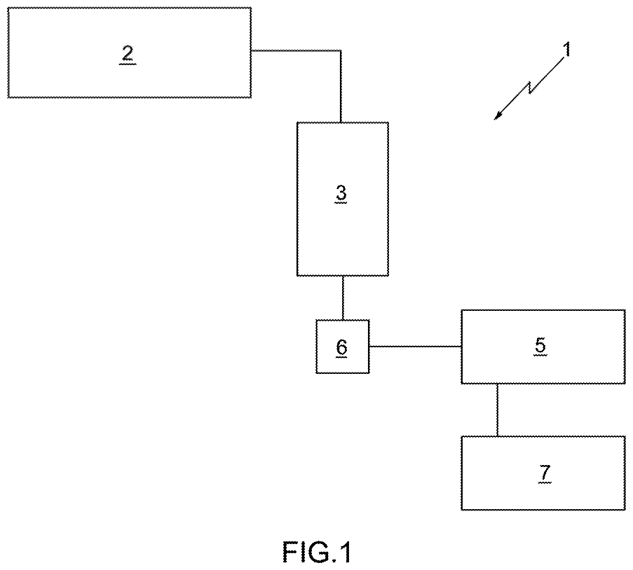

In FIG. 1, number 1 indicates, as a whole, the puffing plant according to the invention.

The plant 1 comprises, in its essential parts, a cooker/dryer assembly 2, which is supplied with pasta or raw legumes and is designed to carry out a cooking of the pasta or of the legumes and a partial drying thereof, a puffing assembly 3, where the cooked pasta or the cooked legumes are puffed, a collecting tank 5, into which the puffed pasta or the puffed legumes are spontaneously conveyed, a conveyor 6 to transport the puffed pasta and the puffed legumes from the puffing assembly 3 to the collecting tank 5, and a screening assembly 7.

The cooker/dryer assembly 2 fulfils the function of cooking the pasta and the legumes, expelling part of the humidity contained in the pasta or in the legumes, and bringing them to an ideal temperature without the occurrence of burning phenomena.

The cooking and drying step is extremely delicate when trying to obtain a correct production of puffed pasta and puffed legumes. In particular, experiments have shown that, in order to obtain puffed pasta o puffed legumes according to the invention, the pasta and the legumes must be subjected to the puffing process with a humidity (% by weight) ranging from 8 to 11, with a temperature ranging from 80 to 110° C. and only after having undergone a dry cooking step.

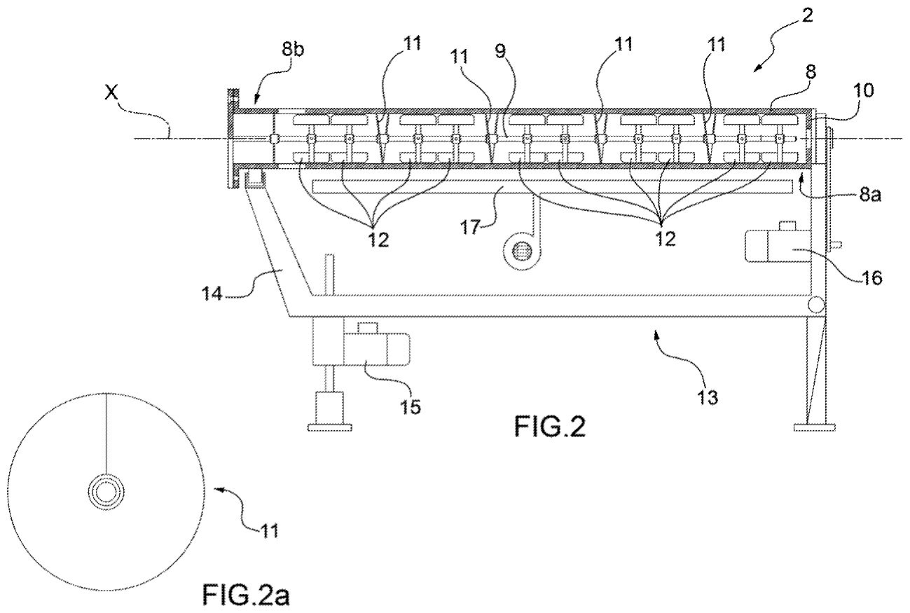

According to FIG. 2, the cooker/dryer 2 comprises a pipe 8 with a cylindrical shape, where the dry cooking and the drying of the pasta and of the legumes take place. The pipe 8 is made of steel and houses, on the inside, a central shaft 9 extending along a longitudinal axis X of the pipe 8. The central shaft 9 is fixed to the pipe 8 in an integral manner and, therefore, rotates with it. A first end 8a of the pipe 8 is closed by a flange 10, where a hole is made in order to allow for the introduction of the pasta and of the legumes to be subjected to the cooking and drying step into the pipe 8. In the pipe 8, close to a second end 8b, there are holes with en elliptical shape, which allow the pasta and the legumes already subjected to the dry cooking and drying step to come out of the pipe 8.

A plurality of controlled running partitions 11 are fitted to the central shaft 9 with a reversible fixing and a plurality of mixers 12 are arranged in an alternated position relative to the controlled running partitions 11.

According to FIGS. 2 and 2a, each one of said controlled running partitions 11 consists of a wall with a radially cut circular plan, where a central hole is made, which, in use, is engaged by the central shaft 9 and has a spiral surface development. This conformation of the controlled running partitions 11 creates a winding passageway for the pasta and the legumes during the dry cooking and drying process. By so doing, the controlled running partitions 11 make sure that the material remains inside the pipe 8 for the time needed in order to obtain a correct cooking and drying.

Each one of the mixers 12 consists of two blades extending on opposite sides of the central shaft 9. The mixers 12 have the task of keeping the material moving inside the pipe 8, thus preventing it from burning.

As already mentioned above, the controlled running partitions 11 and the mixers 12 are fitted on the central shaft 9, where they are locked in a reversible manner. In this way, their position on the shaft 9 can be changed in order to optimize the parameters of the cooking and drying step.

The cooking/drying assembly 2 comprises a support structure 13 for the pipe 8. The support structure 13 comprises a pivoting articulated joint 14, which acts upon the second end 8b of the pipe 8 and is controlled by a motor-variator 15 so as to change the inclination of the pipe 8.

The support structure 13 bears a second motor-variator 16, which, by means of a transmission chain, controls the rotation of the pipe 8 around its longitudinal axis X.

The two motor-variators 15 and 16 fulfil the function of changing the inclination and the speed, respectively, of the pipe 8 so as to allow for an optimal cooking and drying process.

The production of puffed pasta and legumes, unlike the production of traditional puffed cereals, such as puffed corn or puffed rice, requires the pasta and the legumes to be previously cooked and to have a given content of humidity as well as a given temperature. Owing to the above, it is evident that being able of optimizing the parameters concerning the cooking and drying step is extremely important. In particular, the possibility of changing the inclination and the rotation speed of the pipe 8 is a huge advantage to ensure the optimization of the dry cooking and drying step.

Indeed, the speed of rotation of the pipe 8 and the inclination thereof make sure that the pasta and the legumes coming out of the pipe 8 are correctly cooked and have the ideal degree of drying as well as the right temperature for the puffing step.

Finally, the cooker/dryer assembly 2 comprises a burner 17, which is designed to act upon the pipe 8 so as to ensure a cooking temperature inside the pipe 8 ranging from 110 to 150° C.

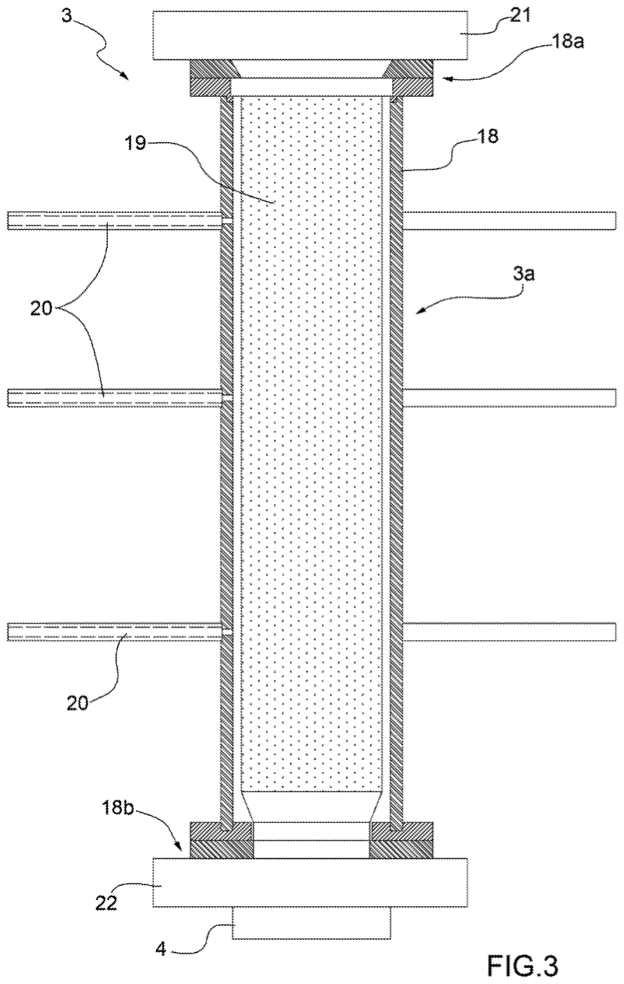

According to FIG. 3, the puffing assembly 3 comprises a puffing reactor 3a, which consists of an outer pipe 18, which is sized so as to be able to stand the pressures and the temperatures required by the process, and of an inner pipe 19, which is arranged inside the outer pipe 18 in a concentric position. The inner pipe 19 consists of a micro-perforated cylindrical wall, with holes of approximately 1 mm. Both the outer pipe 18 and the inner pipe 19 are made of steel.

According to FIG. 3, the puffing assembly comprises a plurality of ducts 20 to introduce steam into the outer pipe 18. The presence of the holes in the inner pipe 19 allows the steam to be uniformly distributed on the entire mass of pasta or legumes. On an upper end 18a of the outer pipe 18 there is mounted a slide valve, schematically shown and indicated with 21, whereas on the lower end 18b there is mounted a buffer cap, schematically shown and indicated with 22, which is designed to seal the outer pipe 18 and is manufactured so as to stand the temperatures and the pressures building up inside the outer pipe 18. In particular, the puffing process takes place by creating, inside the outer pipe 18, a pressure ranging from 7 to 10 bar, preferably from 8 to 9 bar, and a temperature ranging from 170 to 220° C. To this regard, the outer pipe is heated by a series of electric resistances.

The buffer cap 22 is operated by an electric-pneumatic actuator 4.

The presence of the inner pipe 19 prevents part of the pasta or of the legumes from coming into contact with the heated walls of the outer pipe 18. As a matter of fact, the pasta and the legumes, after having come into contact with the hot walls of the outer pipe, get burned and form deposits leading to obvious productivity problems.

Furthermore, the hollow space created between the outer pipe 18 and the inner pipe 19 allows for a more effective distribution of the steam on the pasta or on the legumes to be treated.

Once the buffer cap 22 is moved to its opening position and the pressure inside the outer pipe quickly drops, the pasta or the legumes are subjected to the puffing phenomena and, through the conveyor 6, are distributed inside the collecting tank 5. Subsequently, the puffed pasta or the puffed legumes are conveyed from the collecting tank 5 to the screening assembly 7, which comprises a plurality of sieves, which, by means of an oscillating movement, permit the selection of the product that was just puffed.

The plant according to the invention was used for the preparation of puffed pasta. In particular, Buitoni® short pasta was used, namely of the type short cut pasta for soups. Inside the pipe 8, the pasta was subjected to a temperature ranging from 110 to 120° C. for an amount of time ranging from 40 to 50 seconds.

The inclination and the rotation speed of the pipe 8 were set so as to obtain, coming out of the pipe 8, a pasta with a humidity (% by weight) equal to 9 and a temperature equal to 90° C.

Subsequently, the pasta was subjected to the puffing treatment by means of the puffing assembly 3. The puffing treatment was carried out by subjecting the pasta, inside the inner pipe 19, to a pressure of 9 bar and to a temperature of 200° C. for an mount of time of 60 seconds.

The treated pasta then underwent a series of nutritional analyses in an ISO 17025 certified laboratory.

Table I shows the nutritional values of 100 g of pasta before and after having been subjected to the puffing treatment with the plant according to the invention.

TABLE I

| | Non-puffed pasta | Puffed pasta |
|---|---|---|
| Kilogram calories | 356 | 386 |
| Complex carbohydrates | 71.3 | 80.19 |
| Simple carbohydrates | 3.5 | 2.51 |
| Proteins | 12 | 11.45 |
| Fats | 1.9 | 2.21 |
| Saturated fats | 0.8 | 1.09 |
| Fibres | 3 | 3.54 |

According to the values shown in Table I, the puffed pasta has a greater value of complex carbohydrates and fibres, whereas it has a smaller percentage of simple sugars. With these features, puffed pasta can be used not only by healthy people, but also by people suffering from diabetes, as the larger content of fibres leads to a lower glycemic index compared to the one of non-puffed pasta.

Puffed pasta can also be preferably used by people constantly working out, at breakfast—alone or combined with milk or yoghurt, as cold dish at lunch, at dinner or in the form of bars or snacks to be consumed in every moment of the day.

Just like puffed cereals, puffed pasta and puffed legumes can be frosted with both salted and sweet substances. By so doing, legumes can become tasty also for those who generally do not appreciate them.

Furthermore, puffed pasta can be used in soups, thus going back to the classic consistency of cooked pasta, though keeping at the same time the nutritional features described above.

Hence, the production of puffed pasta or of puffed legumes allows manufacturers to offer, in a practical and easy to be consumed manner (with no need for preparation before being eaten), foods with nutritional properties that make them suited for a healthy life style.

Furthermore, the puffed pasta and the puffed legumes according to the invention, being a ready to be consumed and easily transportable product, can be eaten in any situation, even in those situations that are scarcely organized for consuming meals. To this regard, the puffed pasta and the puffed legumes according to the invention can be particularly suited for humanitarian or military missions.

1. A plant (1) for the production of puffed pasta or puffed legumes; said plant being characterized in that it comprises a cooker/dryer assembly (2), which is supplied with pasta or raw legumes and is designed to carry out a dry cooking of the pasta or of the legumes and a partial drying thereof, a puffing assembly (3), where the pasta or the legumes are puffed, and a collecting tank (5), into which the pasta or the legumes that have been subjected to the puffing process are conveyed; said cooker/dryer assembly (2) comprising a cooking pipe (8), which is designed to house pasta or legumes in a running manner, heating means (17), which are designed to heat the pipe (8), moving means (16), which are designed to rotate the pipe (8) around a longitudinal axis (X) thereof, inclination means (14, 15), which are designed to incline the pipe (8), a plurality of controlled running partitions (11), which are housed inside the pipe (8) and are designed to slow down the running of pasta or legumes inside the pipe (8), and a plurality of mixers (12), which are housed inside the pipe (8) and are designed to mix pasta or legumes inside the pipe (8).

2. A plant (1) for the production of puffed pasta or puffed legumes according to claim 1, characterized in that said pipe (8) houses, on the inside and in an integral form, a central shaft (9) arranged along the axis (X); said controlled running partitions (11) and said mixers (12) being fixed to said central shaft (9) in a reversible manner and in an alternated position.

3. A plant (1) for the production of puffed pasta or puffed legumes according to claim 2, characterized in that each one of said controlled running partitions (11) consists of a wall with a circular plan, where a central hole is made, which, in use, is engaged by said central shaft (9) and has a spiral surface development.

4. A plant (1) for the production of puffed pasta or puffed legumes according to claim 2, characterized in that each one of the mixers (12) consists of two blades extending on opposite sides of the central shaft (9).

5. A plant (1) for the production of puffed pasta or puffed legumes according to claim 1, characterized in that said inclination means comprise a pivoting articulated joint (14) of a support structure (13) of the pipe (8) and a motor-variator (15), which acts upon the pivoting articulated joint (14).

6. A plant (1) for the production of puffed pasta or puffed legumes according to claim 1, characterized in that said puffing assembly (3) comprises a puffing reactor (3a), which consists of an outer pipe (18), which is sized so as to be able to stand the pressures and the temperatures required by the process, and of an inner pipe (19), which is arranged inside the outer pipe (18) in a concentric position; said inner pipe (19) consisting of a micro-perforated cylindrical wall.

7. A plant (1) for the production of puffed pasta or puffed legumes according to claim 6, characterized in that the holes of the cylindrical wall of said inner pipe (19) have a diameter ranging from 1 to 1.5 mm.

8. (canceled)

9. (canceled)

10. A method for the production of puffed pasta, characterized in that it comprises, in succession, a cooking/drying step, during which the pasta is subjected to a temperature ranging from 110 to 150° C. and comprises, at the end of said step, a humidity (% by weight) ranging from 8 to 10; and a puffing step, during which the pasta resulting from said cooking/drying step and having a temperature ranging from 80 to 110° C. is subjected to a temperature ranging from 170 to 220° C. and to an overpressure ranging from 6 to 13 bar.
